(19) United States
(12) Patent Application Publication
(10) Pub. No.: US 2017/0284396 A1
(43) Pub. Date: Oct. 5, 2017

(54) ELECTRIC COMPRESSOR

(71) Applicant: KABUSHIKI KAISHA TOYOTA JIDOSHOKKI, Kariya-shi (JP)

(72) Inventors: Hiroshi FUKASAKU, Aichi-ken (JP); Ken SUITOU, Aichi-ken (JP)

(73) Assignee: KABUSHIKI KAISHA TOYOTA JIDOSHOKKI, Kariya-shi (JP)

(21) Appl. No.: 15/472,792

(22) Filed: Mar. 29, 2017

(30) Foreign Application Priority Data
Mar. 31, 2016 (JP) 2016-072533

(51) Int. Cl. F04C 29/00; F04C 18/344; H02K 7/14; H02K 1/14; H02K 5/04; F04C 18/02; F04C 21/00

(52) U.S. Cl. CPC F04C 29/0085; F04C 18/0215; F04C 18/344; F04C 21/00; H02K 1/146; H02K 5/04; H02K 7/14; F04C 2210/26; F04C 2240/40; F04C 2240/30; F04C 2240/60

(57) ABSTRACT

An electric compressor includes a housing, a rotary shaft, a compression portion compressing refrigerant gas, a stator, a rotor, and guide members disposed between the housing and the stator and spaced away from each other in a peripheral direction of the rotary shaft. The guide members include an engagement portion projecting in a radially outward direction of the rotary shaft. The housing has in an inner peripheral surface thereof an engagement hole to receive the engagement portion. An electric compressor includes a housing, a rotary shaft, a compression portion compressing refrigerant gas, a stator, a rotor, and guide members disposed between the housing and the stator and spaced away from each other in a peripheral direction of the rotary shaft. An engagement projection is formed projecting radially inwardly from the inner peripheral surface of the housing. The guide members include an engagement hole to receive the engagement projection.

### BACKGROUND OF THE INVENTION

The present invention relates to an electric compressor,

In general electric compressors, a stator of an electric motor is shrink-fitted to an electric motor. However, apparatuses for shrink fitting are large in size and expensive, and the cycle time for the shrink fitting is prolonged by the necessity of time for heating and cooling. Furthermore, high dimensional accuracy is required for the inner diameter of a housing and the outer diameter of a stator. Japanese Patent Application Publication 2014-20231 discloses an electric compressor in which a guide member made of a sheet material is provided on the outer periphery of the stator and the stator is press-fitted on the inner peripheral surface of the housing by way of the guide member.

In the electric compressor of the above Publication, the guide member is movable in the peripheral direction of the rotary shaft relative to the housing and therefore, displacement or slippage of the guide member in the peripheral direction of the rotary shaft relative to the housing may occur in press-fitting operation, with the result that the stator core may be damaged due to the contact of the stator core and the housing.

The present invention which has been made in light of the above problems is directed to providing an electric compressor in which the displacement or slippage of the guide member in the peripheral direction of the rotary shaft relative to the housing is restricted.

### SUMMARY OF THE INVENTION

In accordance with a first aspect of the present invention, there is provided an electric compressor including a cylindrical housing, a rotary shaft accommodated and rotatably supported in the housing, a compression portion compressing refrigerant gas by rotation of the rotary shaft, a stator accommodated in the housing and fixed to an inner peripheral surface of the housing, a rotor accommodated in the housing and fixed on the rotary shaft, and a plurality of guide members disposed between the inner peripheral surface of the housing and an outer peripheral surface of a stator core of the stator and spaced away from each other in a peripheral direction of the rotary shaft. The guide members include an engagement portion projecting in a radially outward direction of the rotary shaft. The housing has in the inner peripheral surface thereof an engagement hole to receive the engagement portion.

In accordance with a second aspect of the present invention, there is provided an electric compressor including a cylindrical housing, a rotary shaft accommodated and rotatably supported in the housing, a compression portion compressing refrigerant gas by rotation of the rotary shaft, a stator accommodated in the housing and fixed to an inner peripheral surface of the housing, a rotor accommodated in the housing and fixed on the rotary shaft, and a plurality of guide members disposed between the inner peripheral surface of the housing and an outer peripheral surface of a stator core of the stator and spaced away from each other in a peripheral direction of the rotary shaft. An engagement projection is formed projecting in a radially inward direction of the rotary shaft in the inner peripheral surface of the housing. The guide members include an engagement hole to receive an engagement projection.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a longitudinal sectional view of an electric compressor according to a first embodiment of the present invention;

FIG. 2 is a transverse sectional view of the electric compressor taken along the line 2-2 of FIG. 1;

FIG. 3A is a fragmentary front view showing a stator core of a stator and a guide member of the electric compressor of FIG. 1;

FIG. 3B is a fragmentary sectional side view showing a motor housing, as well as the stator core and the guide member, of the electric compressor taken along the line A-A of FIG. 3A;

FIG. 3C is a fragmentary sectional view of the electric compressor taken along the line B-B of FIG. 3A;

FIG. 4 is a perspective view of the guide member of FIGS. 3A to 3C;

FIG. 5 is a fragmentary perspective view of the motor housing of FIG. 1;

FIG. 6 is a longitudinal sectional view of the electric compressor of FIG. 1, showing a manner in which the stator is press-fitted in the motor housing;

FIG. 7A is a fragmentary front view similar to FIG. 3A, but showing an electric compressor according to a second embodiment of the present invention;

FIG. 7B is a fragmentary sectional view taken along the line A-A of FIG. 7A;

FIG. 7C is a fragmentary sectional view taken along the line B-B of FIG.

FIG. 8A is a perspective view of a guide member of an electric compressor according to another embodiment of the present invention;

FIG. 8B is a perspective view of the guide member of the electric compressor of FIG. 8A; and

FIG. 9 is a fragmentary sectional view similar o FIG. 7C, but showing the electric compressor of FIG. 8A.

### DETAILED DESCRIPTION OF THE EMBODIMENTS

### First Embodiment

The following will describe an embodiment according to the present invention with reference to the accompanying drawings. An electric compressor according to the present embodiment is designated by 10 and used for a vehicle air conditioner.

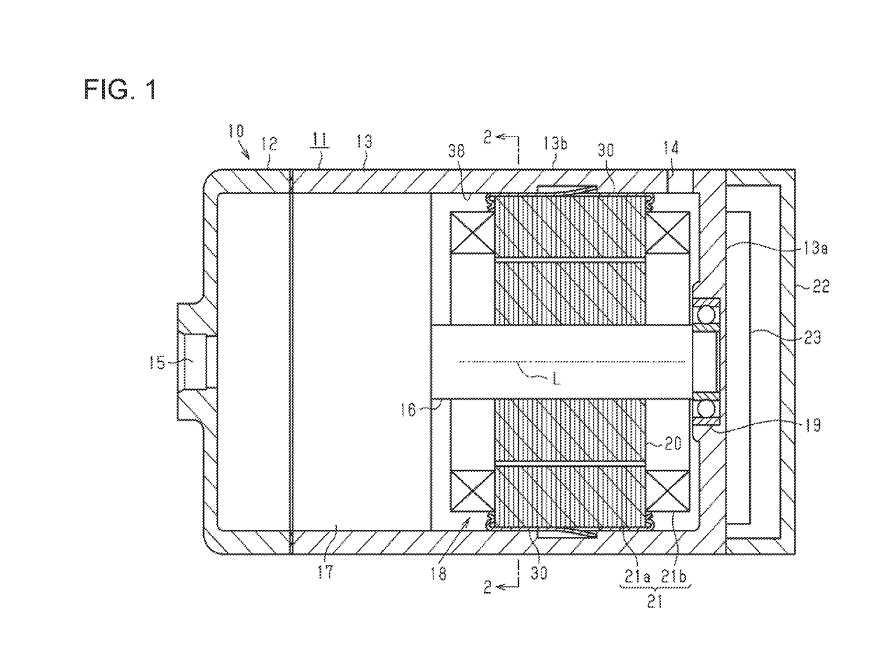

Referring to FIG. 1, the electric compressor 10 has a housing 11 including a discharge housing 12 and a motor housing 13 connected to the discharge housing 12 both of which have a bottomed cylindrical shape and are made of a metal such as aluminum alloy. The motor housing 13 has therethrough an inlet port 14 that is connected to an external refrigerant circuit not shown in the drawing. The motor housing 13 has a bottom wall 13a and a cylindrical side wall 13b extending axially of the compressor from the outer peripheral edge of the bottom wall 13a. The discharge housing 12 has therethrough an outlet port 15 that is connected to the external refrigerant circuit.

The motor housing 13 has therein a rotary shaft 16, a compression portion 17 having a compression chamber therein and driven by the rotary shaft 16 for compressing refrigerant gas, and an electric motor 18 rotating the rotary shaft 16. As the compression portion 17 a scroll type compressor, a piston type compressor, or a vane type compressor may be applied. The compression portion 17 and the electric motor 18 are disposed side by side in the direction of the rotational axis L of the rotary shaft 16. As shown in FIG. 1, the electric motor 18 is disposed closer to the bottom wall 13a of the motor housing 13 than the compression portion 17 is,

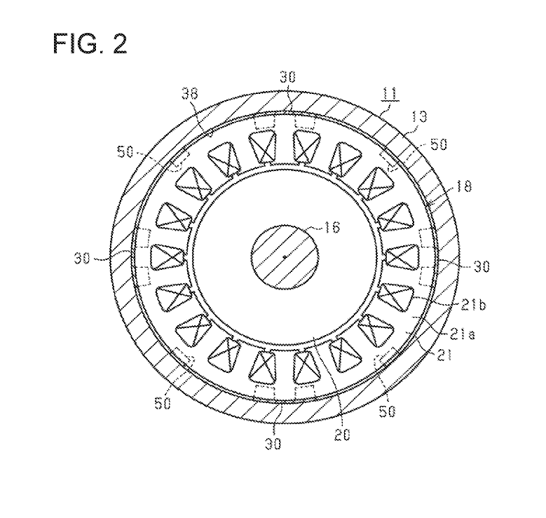

The rotary shaft 16 is rotatably supported by the bottom wall 13a of the motor housing 13 through a bearing 19, As shown in FIGS. 1 and 2, the electric motor 18 has a rotor 20 mounted on the rotary shaft 16 for rotation therewith and a stator 21 surrounding the rotor 20. The rotor 20 is fixed on the rotary shaft 16. The stator 21 has a cylindrical stator core 21a and a coil 21b wound around the stator core 21a. The stator core 21a is made of a plurality of laminated core sheets made of a metallic magnetic material such as an electromagnetic steel.

Referring to FIG, 1, a cover 22 has a bottomed cylindrical shape and is fixed to the bottom wall 13a of the motor housing 13. A motor drive circuit 23 is accommodated in the space formed by the bottom wall 13a of the motor housing 13 and the cover 22 to drive the electric motor 18. The motor drive circuit 23 and the coil 21b are electrically connected with each other.

Thus, the electric compressor 10 includes the cylindrical motor housing 13, the rotary shaft 16 accommodated and rotatably supported in the motor housing 13, and the compression portion 17 compressing refrigerant gas with the rotation of the rotary shaft 16. The electric compressor 10 further includes the stator 21 accommodated in the motor housing 13 and fixed to the inner peripheral surface 38 of the motor housing 13, or, to the inner peripheral surface of the side wall 13b and the rotor 20 accommodated in the motor housing 13 and fixed on the rotary shaft 16.

As shown in FIGS. 1, 2, 3A, 3B, and 30, the stator core 21a is fitted to the inner peripheral surface 38 of the motor housing 13 by press-fitting with guide members 30 provided on the outer peripheral surface 39 of the stator 21, so that the stator core 21a is assembled to the motor housing 13.

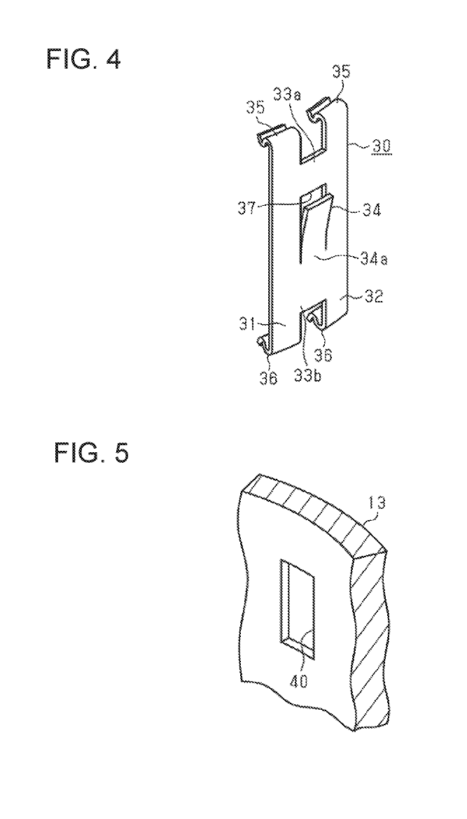

As shown in FIG. 4, the guide member 30 is made of a steel plate. As shown in FIG. 2, in the present embodiment, four guide members 30 are disposed 90 degrees apart from each other in the motor housing 13 in the peripheral direction of the motor housing 13, which corresponds to the peripheral direction of the rotary shaft 16. That is, the plural guide members 30 (four guide members in the present embodiment) are disposed in contact with the outer peripheral surface 39 of the stator core 21a of the stator 21 and extend in the axial direction of the rotary shaft 16 between the inner peripheral surface 38 of the motor housing 13 and the outer peripheral surface 39 of the stator core 21a of the stator 21, and are spaced apart from each other in the peripheral direction of the rotary shaft 16.

The stator core 21a of the stator 21 is made of a plurality of laminated electromagnetic steel plates. If such stator 21 is press-fitted in the motor housing 13 without using guide members such as 30, stress due to press-fitting is applied directly to the stator core 21a. The provision of the guide members 30 between the inner peripheral surface 38 of the motor housing 13 and the outer peripheral surface 39 of the stator core 21a prevents stress in press-fitting from being applied directly to the stator core 21a.

As shown in FIG. 4, the guide member 30 has a pair of strip portions 31, 32 of a rectangular shape and a pair of connecting portions 33a, 33b connecting the paired strip portions 31, 32. The strip portions 31, 32 are spaced away from each other in their width direction and integrated by the paired connecting portions 33a, 33b. The connecting portions 33a, 33b are spaced away from each other in the longitudinal direction of the strip portions 31, 32. The guide member 30 is bent in an arc shape so that the opposite surfaces thereof correspond to the inner peripheral surface 38 of the motor housing 13 and the outer peripheral surface 39 of the stator core 21a, respectively, and extend along the surfaces 38, 39.

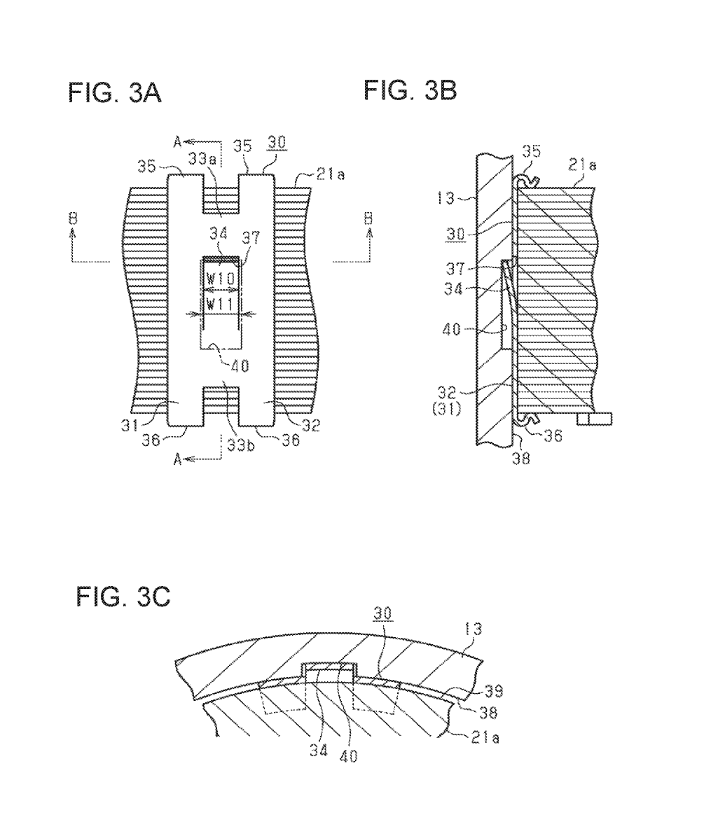

Each of the strip portions 31, 32 of the guide member 30 has at the opposite longitudinal ends thereof bent portions 35, 36. As shown in FIG. 3B, the guide member 30 is fitted in the stator core 21a with the bent portions 35, 36 thereof facing the opposite axial ends of the stator core 21a.

As shown in FIG. 4, the guide member 30 includes an engagement portion 34 bent in the radially outward direction of the rotary shaft 16 (in the thickness direction of the strip portions 31, 32 and the connecting portions 33a, 33b) and an accommodation hole 37. The engagement portion 34 of the guide member 30 is of a rectangular shape and bent or curved in an arc-like shape from the connecting portion 33b to the distal end thereof and serves as an engagement projection. The accommodation hole 37 is rectangularly shaped complementary to the shape of the engagement portion 34 and defined by the strip portions 31, 32, the connecting portion 33a, and a proximal end portion 34a of the engagement portion 34.

It is noted that according to the present invention, the guide member such as 30 may have a structure in which a single strip portion is formed or three or more strip portions are disposed side by side and connected by connecting portions. Furthermore, the bent portions 35, 36 may be dispensed with. That is, the guide member may be formed having only a plate and an engagement portion bent from the plate in the radially outward direction of the rotary shaft (in the thickness direction of the plate).

The engagement portion 34 is elastically deformed by receiving load from the direction opposite to the direction in which the engagement portion 34 projects and is received in the accommodation hole 37 that is a through hole.

As shown in FIG. 5, the motor housing 13 has therein an engagement hole 40 to receive therein the engagement portion 34. In the present embodiment, the engagement hole 40 is provided in the form of a recess. As shown in FIG. 3A, the engagement hole 40 which is formed in the inner peripheral surface 38 of the motor housing 13 has a width W11 extending in the peripheral direction of the rotary shaft 16. The width W11 of the engagement hole 40 is slightly greater than the width W10 of the engagement portion 34 as measured in the peripheral direction of the rotary shaft 16. Thus, when the engagement hole 40 receives therein the engagement portion 34, the movement of the stator 21 in the peripheral direction of the rotary shaft 16 is regulated.

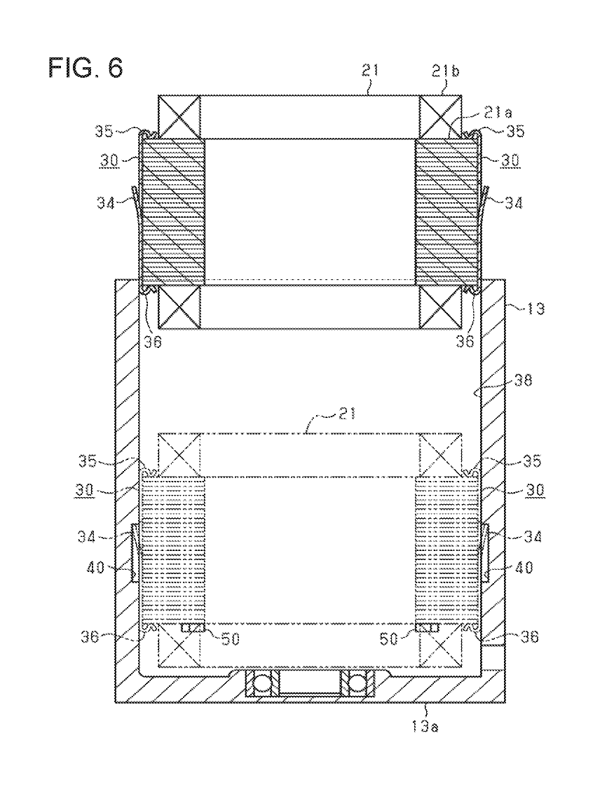

In press-fitting of the stator core 21a, the engagement portion 34 is brought into contact with the inner peripheral surface 38 of the motor housing 13, and, being pressed, elastically deformed into a flat state by receiving load from the direction opposite to the direction in which the engagement portion 34 projects. Thus, the engagement portion 34 is brought into and received by the accommodation hole 37. When the engagement portion 34 comes to the position of the engagement hole 40 and is placed in the engagement hole 40, as shown in FIG. 6, the engagement portion 34 is restored to its bent state from the connecting portion 33b toward the distal end, receiving no load from the inner peripheral surface 38 of the motor housing 13. That is, the accommodation hole 37 of the guide member 30 is configured to receive therein the engagement portion 34 when elastically deformed by receiving load from the direction opposite to the direction in which the engagement portion 34 projects.

As shown in FIGS. 2 and 6, projections 50 are formed projecting in the radially inward direction of the rotary shaft 16 from the inner peripheral surface 38 of the motor housing 13. The projections 50 serve as a stop to regulate movement of the stator core 21a in the axial direction of the rotary shaft 16 by contacting the stator core 21a or the guide member 30. In the drawings of the present embodiment, the projections 50 are shown to be in contact with the stator core 21a. That is, the press-fitting of the stator 21 into the motor housing 13 is completed when the stator core 21a is brought into contact with the projections 50. Although the projections 50 may be provided at positions where the projections 50 becomes in contact with the guide members 30, the projections 50 should preferably be provided away from the guide member 30 in order to prevent the guide members 30 from being deformed due to the contact with the projections 50.

As shown in FIG. 2, the four projections 50 are disposed 90 degrees apart from each other in the motor housing 13 in the peripheral direction of the motor housing 13 (the peripheral direction of the rotary shaft 16 relative to the motor housing 13). It is noted that the number of the projections 50 is not limited to four.

The following will describe the function of the electric compressor 10 of the present embodiment. As shown in FIG. 6, the stator 21 is press-fitted from the solid-line position to the predetermined fitting position indicated by the phantom line in the motor housing 13 through the guide members 30.

By disposing the guide members 30 between the inner peripheral surface 38 of the motor housing 13 and the outer peripheral surface 39 of the stator core 21a, pressure is not directly applied to the stator core 21a in press-fitting of the stator core 21a, thereby to protect the stator core 21a made of electromagnetic steel.

The structure in which the engagement portion 34 of the guide member 30 is received in the engagement hole 40 of the motor housing 13 prevents the guide member 30 from being moved in the peripheral direction of the rotary shaft 16. That is, the guide member 30 is prevented from being displaced relative to the motor housing 13 in the peripheral direction of the rotary shaft 16. As a result, the guide member 30 may be disposed at any position in the peripheral direction of the rotary shaft 16 between the inner peripheral surface 38 of the motor housing 13 and the outer peripheral surface 39 of the stator core 21a, restricting a contact of the stator core 21a with the inner peripheral surface 38 of the motor housing 13.

In the electric compressor of the above-cited Japanese Patent Application Publication 2014-20231, there is a fear that in press-fitting of the guide members the guide members may be displaced relative to the motor housing in the peripheral direction of the rotary shaft, with the result that the stator core may be damaged by contact of the stator core and the housing.

According to the present embodiment, the guide members 30 are prevented from being moved relative to the motor housing 13 in the peripheral direction of the rotary shaft 16 and therefore, the contact of the stator core 21a and the inner peripheral surface 38 of the motor housing 13 is restricted.

As is apparent from the foregoing, the provision of the engagement portion 34 and the engagement hole 40 permits to regulate movement of the guide member 30 relative to the motor housing 13 in the peripheral direction of the rotary shaft 16. It is noted that according to the present invention, the number of the engagement portions 34 is not limited and also that the accommodation hole 37 may be provided in the form of a recess.

According to the above-described embodiment, the following advantageous effects are obtained.

(1) In the present embodiment in which the engagement portion 34 is formed in the guide members 30 and the engagement holes 40 are formed in the housing 13, the guide members 30 is prevented from being moved relative to the motor housing 13 in the peripheral direction of the rotary shaft 16 and, therefore, the contact of the stator core 21a with the inner peripheral surface 38 of the motor housing 13 is restricted.

(2) The projections 50 which are provided on the inner peripheral surface 38 of the motor housing 13 serve as stops to regulate the movement of the stator core 21a toward the bottom wall 13a of the motor housing 13 in the axial direction of the rotary shaft 16.

### Second Embodiment

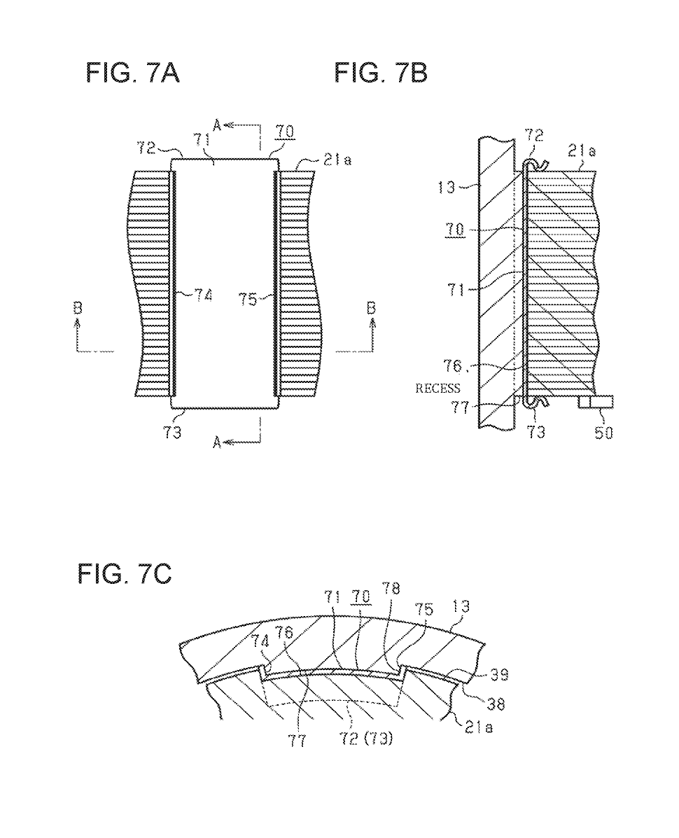

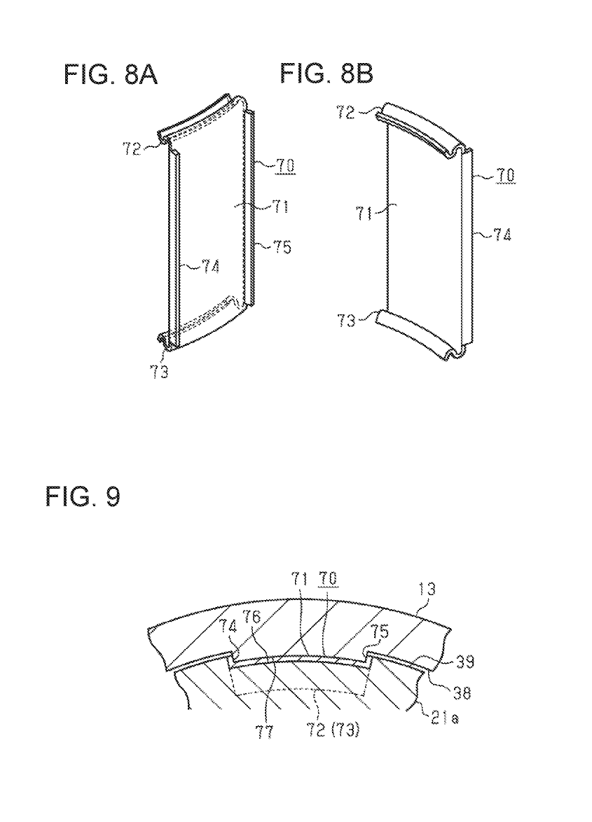

The following will describe a second embodiment focusing on the difference from the first embodiment. In the first embodiment, the engagement holes 40 are formed in the motor housing 13 and the engagement portions 34 are formed in the respective guide members 30, as shown in FIGS. 3, 4, and 5. In the second embodiment, engagement projections 77 (only one engagement portion being shown in the drawings), which correspond to the engagement holes 40 in the first embodiment, are formed extending from the inner peripheral surface 38 of the motor housing 13 and a guide member 70 having a recessed portion 78, which corresponds to the guide member 30 in the first embodiment, is used, as shown in FIGS. 7A, 7B, 7C, 8A and 8B.

As shown in FIGS. 7A, 7B, and 7C, the engagement projection 77 is formed projecting in the radially inward direction of the rotary shaft 16 from the inner peripheral surface 38 of the motor housing 13 to the stator core 21a. The guide member 70 has therein a recessed portion 78 serving as an engagement hole to receive therein the engagement projection 77. Specifically, as shown in FIGS. 8A and 8B, the guide member 70 includes a single strip portion 71 having a rectangular shape, bent portions 72, 73 at the opposite longitudinal ends of the strip portion 71, and a pair of flanges 74, 75 that are formed at the opposite lateral sides of the strip portion 71. The flanges 74, 75 have a constant height as measured from the strip portion 71 throughout the length of the flanges and project in the thickness direction of the strip portion 71.

The bent portions 72, 73 are bent in the direction opposite to the projecting direction of the flanges 74, 75. As shown in FIG. 7C, the guide member 70 is fitted in a recess 76 formed in the stator core 21a of the stator 21 in such a way that the flanges 74, 75 project in the radially outward direction of the rotary shaft 16 and serving as an engagement hole. The depth of the recess 76 is greater than the thickness of the guide member 70, the flanges 74, 75 of the guide member 70 project in the radially outward direction of the rotary shaft 16 beyond the outer peripheral surface 39 of the stator core 21a, and the engagement projection 77 is fitted between the flanges 74, 75.

Such structure regulates the displacement of the guide member 70 relative to the motor housing 13 in the peripheral direction of the rotary shaft 16. The engagement projection 77 which is formed projecting from the inner peripheral surface 38 of the motor housing 13 is not limited to the size shown in FIG. 7B and may be of any size as long as the stator core 21a is held securely in the press-fitting of the stator core 21a so that the position of the stator core 21a is not changed by vibration generated by the electric compressor.

According to the above-described second embodiment, the following advantageous effects are obtained.

(3) The structure in which the engagement projection 77 is provided in the motor housing 13 and the recessed portion 78 is provided in the guide member 70 prevents the guide member 70 from being moved in the peripheral direction of the rotary shaft 16 by the motor housing 13. Therefore, contact of the stator core 21a and the inner peripheral surface 38 of the motor housing 13 is restricted.

The present invention is not limited to the above-described embodiments, but may be modified into various alternative embodiments, as exemplified below.

The engagement portion 34 of the guide member 30 having a rectangular shape and bent in an arc shape from the connecting portion 33b may be formed otherwise. The guide member 30 may dispense with the accommodation hole 37, That is, the guide member may be formed having only a plate and an engagement portion extending from the plate in the radially outward direction of the rotary shaft, or in the thickness direction of the plate. For example, it is conceivable to provide a guide member having only a plate and an engagement portion projecting from the plate and having a hemispherical shape.

In the structure shown in FIGS. 7A, 76, and 70, flange portions may be provided extending in the peripheral direction of the rotary shaft 16 from the upper edges of the flanges 74, 75, or the edges of the flanges 74, 75 on the opposite side to the strip portion 71. In this case, if the press-fitting may be performed through the flange portions, the flanges 74, 75 and the strip portion 71 may be spaced away from the engagement projection 77 and/or the recess 76. Furthermore, the size of the engagement projection 77 may be changed as long as the movement of the guide member 70 in the peripheral direction of the rotary shaft 16 relative to the motor housing 13 is regulated.

As will be appreciated from comparison of FIG, 9 with FIGS. 7A, 7B, and 7C, it may be so arranged that the flanges 74, 75 are not in contact with the inner peripheral surface 38 of the motor housing 13. In this case, the engagement projection 77 extending from the inner peripheral surface 38 of the motor housing 13 may be of any size as long as the stator core 21a as press-fitting in the motor housing 13 with the guide member 30 is held securely so that the position of the stator core 21a is not changed by the vibration of the electric compressor.

In the above embodiments shown in FIGS. 7 and 9, the guide member 70 is fitted in the recess 76 of the stator core 21a, but the stator core 21a may have no recess and the guide member 30 may be provided on the outer peripheral surface of the stator core 21a.

The number of the guide members 30 or 70, which are spaced away from each other in the peripheral direction of the rotary shaft 16 may be changed as desired, The number may be two, three, five or more.

The guide member 70 may be fixed to the stator core 21a with adhesive. Specifically, the guide member 70 may be fixed to the stator core 21a with adhesive applied previously to the bottom of the recess 76. In this case, the guide member 70 may dispense with the bent portions 72, and 73.

The shape of the guide member 30 or 70 is not limited to a rectangular shape, but may be changed. The electric compressor 10 may be used for any other applications than vehicles.

What is claimed is:

1. An electric compressor comprising:
a cylindrical housing;
a rotary shaft accommodated and rotatably supported in the housing;
a compression portion compressing refrigerant gas by rotation of the rotary shaft;
a stator accommodated in the housing and fixed to an inner peripheral surface of the housing;
a rotor accommodated in the housing and fixed on the rotary shaft; and
a plurality of guide members disposed between the inner peripheral surface of the housing and an outer peripheral surface of a stator core of the stator and spaced away from each other in a peripheral direction of the rotary shaft, wherein the guide members include an engagement portion projecting in a radially outward direction of the rotary shaft, and wherein the housing has in the inner peripheral surface thereof an engagement hole to receive the engagement portion.

2. The electric compressor according to claim 1, wherein the engagement portion is elastically deformed by receiving load from a direction opposite to a direction in which the engagement portion extends, and wherein the guide members have therein an accommodation hole that receives therein the engagement portion when the engagement portion is elastically deformed by receiving load from the direction opposite to the direction in which the engagement portion projects.

3. The electric compressor according to claim 1, wherein a projection is provided on the inner peripheral surface of the housing and extends in the radially inward direction of the rotary shaft, and wherein the projection serves as a stop to regulate movement of the stator core in an axial direction of the rotary shaft by contacting with the stator core or one of the guide members.

4. An electric compressor comprising:
a cylindrical housing;
a rotary shaft accommodated and rotatably supported in the housing;
a compression portion compressing refrigerant gas by rotation of the rotary shaft;
a stator accommodated in the housing and fixed to an inner peripheral surface of the housing;
a rotor accommodated in the housing and fixed on the rotary shaft; and
a plurality of guide members disposed between the inner peripheral surface of the housing and an outer peripheral surface of a stator core of the stator and spaced away from each other in a peripheral direction of the rotary shaft, wherein an engagement projection is formed projecting radially inwardly from the inner peripheral surface of the housing, and wherein the guide members include an engagement hole to receive the engagement projection.

5. The electric compressor according to claim 4, wherein a projection is provided on the inner peripheral surface of the housing and extends in the radially inward direction of the rotary shaft, and wherein the projection serves as a stop to regulate movement of the stator core in an axial direction of the rotary shaft by contacting with the stator core or one of the guide members.
